(19) United States
(12) Patent Application Publication
(10) Pub. No.: US 2015/0178306 A1
(43) Pub. Date: Jun. 25, 2015

(54) METHOD AND APPARATUS FOR CLUSTERING PORTABLE EXECUTABLE FILES

(71) Applicant: TENCENT TECHNOLOGY (SHENZHEN) COMPANY LIMITED, Shenzhen (CN)

(72) Inventors: Yi Yang, Shenzhen (CN); Tao Yu, Shenzhen (CN); Zi Pan Bai, Shenzhen (CN); Jing Bing Cui, Shenzhen (CN); Jia Xu Wu, Shenzhen (CN)

(21) Appl. No.: 14/637,343

(22) Filed: Mar. 3, 2015

Related U.S. Application Data
(63) Continuation of application No. PCT/CN2013/081137, filed on Aug. 9, 2013.

(30) Foreign Application Priority Data
Sep. 3, 2012 (CN) 201210321468.1

(51) Int. Cl. G06F 17/30

(52) U.S. Cl. CPC G06F 17/30138; G06F 17/30082

(57) ABSTRACT

The present invention relates to Internet and communication technologies, and discloses a method and apparatus for clustering portable executable (PE) files. The method comprises: extracting PE file characteristics from a PE file; generating a PE file identifier for the PE file based on the PE file characteristics; and clustering the PE file base on the PE file identifier. The apparatus comprises an extraction module, a generation module, and a clustering module. In accordance with embodiments of the present invention, a PE file identifier is generated for the PE file based on PE file characteristics extracted from the PE file, and the PE files are clustered based on the PE file identifier. Thus, random PE files are clustered into ordered classes, and the number of PE files to be processed by the antivirus clients and servers are reduced, which reduces storage costs, improves matching efficiency and the ability to detect and combat PE virus variants.

### CROSS-REFERENCE TO RELATED APPLICATIONS

This application is a continuation of International Patent Application No. PCT/CN2013/081137, entitled “Method and Apparatus for Clustering Portable Executable Files,” filed on Aug. 9, 2013. This application claims the benefit and priority of Chinese Patent Application No. 201210321468.1, entitled “Method and Apparatus for Clustering Portable Executable Files,” filed on Sep. 3, 2012. The entire disclosures of each of the above applications are incorporated herein by reference.

### TECHNICAL FIELD

The present invention relates to Internet and communication technologies, and more particularly to a method and apparatus for clustering portable executable (PE) files.

### BACKGROUND

With the explosive growth of the Internet and information, the life cycle of computer viruses, worms, Trojans and other malicious programs are becoming shorter and shorter, and there are a large number of viruses threating user security on a daily basis. Most of the viruses are portable executable (PE) files. Although PE viruses are voluminous, they share many similar properties, and can be clustered into classes for analysis and removal.

Currently, there are mainly two methods for clustering PE files. The first method is the traditional PE file clustering method, such as k-means clustering and multi-layer clustering, which first exacts some characteristics from the PE files, then compares the similarity of PE files based on the exacted characteristics, and clusters the PE files based on the similarity of the PE files. The second method is the PE file clustering method based on fuzzy hash, also called Context Triggered Piecewise Hashing (CTPH), which first divides the PE files into multiple pieces, then compares the PE file pieces to determine the similarity of the PE files, and clusters the PE files accordingly.

There are issues with existing methods for clustering PE files.

In the first traditional PE file clustering method, the exacted characteristics need to properly aligned during the comparison of PE files, which is time consuming due to the huge differences among PE files; multiple characteristics are compared, which increases the complexity of the computing; and when new data are added, the existing data need to be clustered again, which results in high storage and processing costs. In the second PE file PE file clustering method based on fuzzy hash in which the PE file is divided into multiple pieces, the hash value of the PE file depends on how the PE file is divided and the size of the divided pieces, which reduces the stability and comparability of the hash value; the internal information of the PE file is not used, and many PE viruses can modify their structures, such as by adding or deleting certain bytes, to create variants with different hash values that cannot be clustered.

### SUMMARY OF THE INVENTION

To address issues in the prior art, the embodiments of the present invention provide a method and apparatus for clustering portable executable (PE) files.

In accordance with one expect of the present invention, a method for clustering portable executable (PE) files is provided, the method comprising: extracting PE file characteristics from a PE file; generating a PE file identifier for the PE file based on the PE file characteristics; and clustering the PE file base on the PE file identifier.

Preferably, the method further comprises, after extracting PE file characteristics from a PE file, forming a PE file characteristic set using the extracted PE file characteristics, wherein the PE file characteristic set comprises at least one PE file characteristic; and wherein generating a PE file identifier for the PE file based on the PE file characteristics comprises generating a PE file identifier for the PE file based on the PE file characteristic set.

Preferably, generating a PE file identifier for the PE file based on the PE file characteristics comprises when a similarity between the extracted PE file characteristics and the PE file characteristics for a second PE file reaches a preset threshold, generating a PE file identifier for the PE file identical to the PE file identifier for the second PF file; and when the similarity between the extracted PE file characteristics and the PE file characteristics for a second PE file does not reach a preset threshold, generating a PE file identifier for the PE file different from the PE file identifier for the second PF file.

Preferably, when the PE file identifier is a number, the method further comprises: when the extracted PE file characteristics are partially identical to the PE file characteristics for the second PE file, determining the difference between the PE file identifier for the PE file and the PE file identifier for the second PE file based on the number of identical PE file characteristics.

Preferably, clustering the PE file base on the PE file identifier comprises: classifying all PE files with the same PE file identifier into a same class; and clustering all PE files in the same class, and identifying all PE file in the same class using the PE file identifier.

In accordance with one expect of the present invention, an apparatus for clustering portable executable (PE) files is provided, the apparatus comprising: an extraction module for extracting PE file characteristics from a PE file; a generation module for generating a PE file identifier for the PE file based on the PE file characteristics; and a clustering module for clustering the PE file base on the PE file identifier.

Preferably, the extraction module is configured for, after extracting PE file characteristics from a PE file, forming a PE file characteristic set using the extracted PE file characteristics, wherein the PE file characteristic set comprises at least one PE file characteristic; and the generation module is configured for generating a PE file identifier for the PE file based on the PE file characteristics comprises generating a PE file identifier for the PE file based on the PE file characteristic set.

Preferably, the generation module comprises a first processing unit for, when a similarity between the extracted PE file characteristics and the PE file characteristics for a second PE file reaches a preset threshold, generating a PE file identifier for the PE file identical to the PE file identifier for the second PF file; and a second processing unit for, when the similarity between the extracted PE file characteristics and the PE file characteristics for a second PE file does not reach a preset threshold, generating a PE file identifier for the PE file different from the PE file identifier for the second PF file.

Preferably, the generating module comprises a third processing unit for, when the extracted PE file characteristics are partially identical to the PE file characteristics for the second PE file, determining the difference between the PE file identifier for the PE file and the PE file identifier for the second PE file based on the number of identical PE file characteristics.

Preferably, the clustering module comprises a clustering unit for classifying all PE files with the same PE file identifier into a same class and clustering all PE files in the same class; and an identification unit for identifying all PE files in the same class using the PE file identifier.

In accordance with embodiments of the present invention, a PE file identifier is generated for the PE file based on PE file characteristics extracted from the PE file, and the PE files are clustered based on the PE file identifier. Thus, random PE files are clustered into ordered classes, and the number of PE files to be processed by the antivirus clients and servers are reduced, which reduces storage costs and improves matching efficiency. Furthermore, the PE file identifier can be used to search similar PE viruses, which improves the ability to detect and combat PE virus variants.

### BRIEF DESCRIPTION OF THE DRAWINGS

To better illustrate the technical features of the embodiments of the present invention, various embodiments of the present invention will be briefly described in conjunction with the accompanying drawings. It is obvious that the draws are but for exemplary embodiments of the present invention, and that a person of ordinary skill in the art may derive additional draws without deviating from the principles of the present invention.

FIG. 1 is an exemplary flowchart for a method for clustering portable executable (PE) files in accordance with a first embodiment of the present invention.

FIG. 2 is an exemplary flowchart for a method for clustering portable executable (PE) files in accordance with a second embodiment of the present invention.

FIG. 3 is an exemplary schematic diagram for an apparatus for clustering portable executable (PE) files in accordance with a third embodiment of the present invention.

### DESCRIPTION OF THE PREFERRED EMBODIMENTS

To better illustrate the purpose, technical feature, and advantages of the embodiments of the present invention, various embodiments of the present invention will be further described in conjunction with the accompanying drawings. In the following discussion, the term “client” may refer to, a client terminal device, which includes but is not limited to, a desktop computer, a laptop, a netbook, a tablet, a mobile phone, a multimedia TV and other electronic equipment, or a client side application program.

### Embodiment One

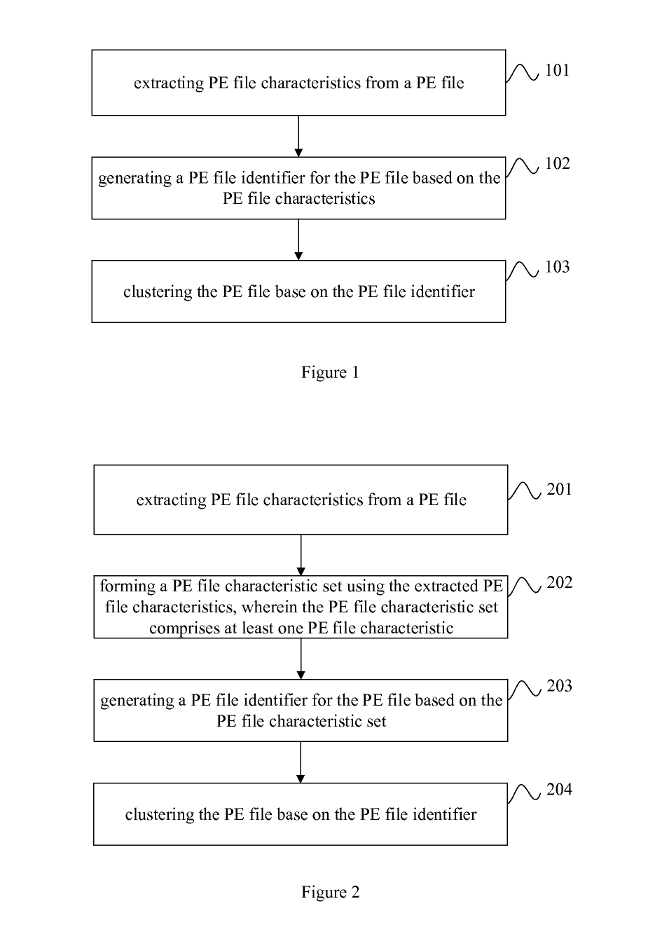

As shown in FIG. 1, a method for clustering portable executable (PE) files is provided in accordance with a first embodiment of the present invention, the method includes:

Step 101: extracting PE file characteristics from a PE file.

Step 102: generating a PE file identifier for the PE file based on the PE file characteristics.

Step 103: clustering the PE file base on the PE file identifier.

Preferably, the method further comprises, after extracting PE file characteristics from a PE file, forming a PE file characteristic set using the extracted PE file characteristics, wherein the PE file characteristic set comprises at least one PE file characteristic; and wherein generating a PE file identifier for the PE file based on the PE file characteristics comprises generating a PE file identifier for the PE file based on the PE file characteristic set.

Preferably, generating a PE file identifier for the PE file based on the PE file characteristics comprises when a similarity between the extracted PE file characteristics and the PE file characteristics for a second PE file reaches a preset threshold, generating a PE file identifier for the PE file identical to the PE file identifier for the second PF file; and when the similarity between the extracted PE file characteristics and the PE file characteristics for a second PE file does not reach a preset threshold, generating a PE file identifier for the PE file different from the PE file identifier for the second PF file.

Preferably, when the PE file identifier is a number, the method further comprises: when the extracted PE file characteristics are partially identical to the PE file characteristics for the second PE file, determining the difference between the PE file identifier for the PE file and the PE file identifier for the second PE file based on the number of identical PE file characteristics.

Preferably, clustering the PE file base on the PE file identifier comprises: classifying all PE files with the same PE file identifier into a same class; and clustering all PE files in the same class, and identifying all PE file in the same class using the PE file identifier.

In accordance with this embodiment, a PE file identifier is generated for the PE file based on PE file characteristics extracted from the PE file, and the PE files are clustered based on the PE file identifier. Thus, random PE files are clustered into ordered classes, and the number of PE files to be processed by the antivirus clients and servers are reduced, which reduces storage costs and improves matching efficiency. Furthermore, the PE file identifier can be used to search similar PE viruses, which improves the ability to detect and combat PE virus variants.

### Embodiment Two

As shown in FIG. 2, a method for clustering portable executable (PE) files is provided in accordance with a first embodiment of the present invention, the method includes:

Step 201: extracting PE file characteristics from a PE file.

Specifically, PE file is a file format under Windows that was widely used. Most of the executable viruses are PE files. The PE file characteristics can be instruction sequence, import function name, export function name and visible strings, or any other characteristics of the PF files. The present embodiment does not limit the number of PE file characteristics. For some PE files, only limited characteristics exist, and only those existing characteristics need to be extracted. For example, if instruction sequence, import function name, and export function name are being extracted from a PE file that has only instruction sequence and import function name, and no export function name, only instruction sequence and import function name need to be extracted.

Step 202: forming a PE file characteristic set using the extracted PE file characteristics, wherein the PE file characteristic set comprises at least one PE file characteristic.)

Preferably, a PE file characteristic set U(u₁, u₂, . . . , uₙ) is formed by the extracted PE file characteristics, wherein (u₁, u₂, . . . , uₙ) represents a combination of the extracted PE file characteristics. As the number of characteristics extracted from different PE files is not necessary the same, the size of the characteristic set U for different PE files can also be different. Furthermore, the order of the characteristics in the characteristic set U for different PE files can also be different.

Step 203: generating a PE file identifier for the PE file based on the PE file characteristic set.

Preferably, a fingerprinting algorithm, such as locality sensitive hash algorithm (SimHash), is applied to the PE file characteristics set to generate a PE file identifier for the PE file characteristics set. The PE file identifier can be a code or a number. The present embodiment does not limit the algorithm for generating the PE file identifier, and other algorithms can be used to generate the PE file identifier.

Preferably, when a similarity between the extracted PE file characteristics and the PE file characteristics for another PE file reaches a preset threshold, the PE file identifier generated from the fingerprinting algorithm for the PE file is identical to the PE file identifier for the other PF file. When the extracted PE file characteristics are exactly the same as the PE file characteristics for another PE file, the generated PE file identifier is the same. When the extracted PE file characteristics are similar to the PE file characteristics for another PE file, a similarity threshold is preset, and the generated PE file identifier is the same if similarity between the extracted PE file characteristics and the PE file characteristics for another PE file reaches the preset threshold. For example, assuming the similarity between the extracted PE file characteristics and the PE file characteristics for another PE file is h and the preset threshold is n, the generated PE file identifier would be the same if h is greater or equal to n.

Preferably, when the similarity between the extracted PE file characteristics and the PE file characteristics for another PE file does not reach a preset threshold, the PE file identifier generated from the fingerprinting algorithm for the PE file is different from the PE file identifier for the other PF file.

Preferably, when the PE file identifier is a number, the method further comprises: when the extracted PE file characteristics are partially identical to the PE file characteristics for another PE file, determining the difference between the PE file identifier for the PE file and the PE file identifier for the other PE file based on the number of identical PE file characteristics: the greater the number of PE file characteristics that are the same as the PE file characteristics for the other PE file, the smaller the difference between the PE file identifier for the PE file and the PE file identifier for the other PE file. For example, if the PE file identifier is calculated using the SimHash algorithm, the greater the number of PE file characteristics u in the PE file characteristic set U, the smaller the Hamming distance the PE file identifier for the PE file and the PE file identifier for the other PE file.

The number of bits of the PE file identifier can be chosen based on the system requirement. The larger the number of bits, the higher is the system requirement. The smaller the number of bits, the lower is the system requirement.

Step 204: clustering the PE file base on the PE file identifier.

Preferably, all PE files with the same PE file identifier are classified into a same class; and all PE files in the same class are clustered together, and identified using the same PE file identifier.

For example, all PE files with the PE file identifier of 10 are classified into a same class; and all PE files in the same class are clustered together, and identified using 10. Thus, if another PE file with a PE file identifier of 10 is found, this PE file can be directly classified into that class, and be analyzed using some of known characteristics for this class of PE files, which can expedite the detection of PE viruses.

In accordance with this embodiment, a PE file identifier is generated for the PE file based on PE file characteristics extracted from the PE file, and the PE files are clustered based on the PE file identifier. Thus, random PE files are clustered into ordered classes, and the number of PE files to be processed by the antivirus clients and servers are reduced, which reduces storage costs and improves matching efficiency. Furthermore, the PE file identifier can be used to search similar PE viruses, which improves the ability to detect and combat PE virus variants.

### Embodiment Three

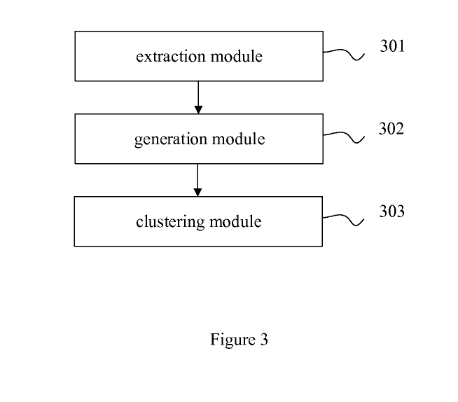

As shown in FIG. 3, an apparatus for clustering portable executable (PE) files is provided in accordance with a second embodiment of the present invention, the apparatus includes: an extraction module 301 for extracting PE file characteristics from a PE file; a generation module 302 for generating a PE file identifier for the PE file based on the PE file characteristics; and a clustering module 303 for clustering the PE file base on the PE file identifier.

Preferably, the extraction module 301 is configured for, after extracting PE file characteristics from a PE file, forming a PE file characteristic set using the extracted PE file characteristics, wherein the PE file characteristic set comprises at least one PE file characteristic; and the generation module 302 is configured for generating a PE file identifier for the PE file based on the PE file characteristics comprises generating a PE file identifier for the PE file based on the PE file characteristic set.

Preferably, the generation module 302 comprises a first processing unit for, when a similarity between the extracted PE file characteristics and the PE file characteristics for a second PE file reaches a preset threshold, generating a PE file identifier for the PE file identical to the PE file identifier for the second PF file; and a second processing unit for, when the similarity between the extracted PE file characteristics and the PE file characteristics for a second PE file does not reach a preset threshold, generating a PE file identifier for the PE file different from the PE file identifier for the second PF file.

Preferably, the generating module 302 comprises a third processing unit for, when the extracted PE file characteristics are partially identical to the PE file characteristics for the second PE file, determining the difference between the PE file identifier for the PE file and the PE file identifier for the second PE file based on the number of identical PE file characteristics.

Preferably, the clustering module 303 comprises a clustering unit for classifying all PE files with the same PE file identifier into a same class and clustering all PE files in the same class; and an identification unit for identifying all PE files in the same class using the PE file identifier.

In sum, in accordance with the apparatus in this embodiment, a unique PE file identifier is generated for the PE file based on PE file characteristics extracted from the PE file, and the PE files are clustered based on the PE file identifier. Thus, random PE files are clustered into ordered classes, and the number of PE files to be processed by the antivirus clients and servers are reduced, which reduces storage costs and improves matching efficiency. Furthermore, the PE file identifier can be used to search similar PE viruses, which improves the ability to detect and combat PE virus variants.

It should be noted that, in the above descriptions, the various modules in the apparatus for clustering portable executable (PE) files are merely exemplary examples used to illustrate the embodiments of the present invention by way of examples. In practice, the various functions can be allocated to different modules based on need, and the apparatus can be divided into different modules to perform the whole or part of the functions described above. In addition, operational principles of the apparatus for clustering portable executable (PE) files in accordance with embodiments of the present invention are the same as those of the methods for clustering portable executable (PE) files, and the method embodiments can be referenced for the implementation details of the apparatus embodiments.

The numbering of the embodiments of the present invention is done solely for convenience, and does not represent the comparative merits of the embodiments. Those skilled in the art will understand that all or part of the embodiments of the present invention can be implemented by computer hardware, or by a computer program controlling the relevant hardware. The computer program can be stored in a computer readable storage media, which can be read-only memory, magnetic disk or optical disk, etc.

The various embodiments of the present invention are merely preferred embodiments, and are not intended to limit the scope of the present invention, which includes any modification, equivalent, or improvement that does not depart from the spirit and principles of the present invention.

1. A method for clustering portable executable (PE) files, the method comprising:
extracting PE file characteristics from a PE file;
generating a PE file identifier for the PE file based on the PE file characteristics; and
clustering the PE file base on the PE file identifier.

2. The method of claim 1, further comprising, after extracting PE file characteristics from a PE file,
forming a PE file characteristic set using the extracted PE file characteristics, wherein the PE file characteristic set comprises at least one PE file characteristic; and
wherein generating a PE file identifier for the PE file based on the PE file characteristics comprises generating a PE file identifier for the PE file based on the PE file characteristic set.

3. The method of claim 1, wherein generating a PE file identifier for the PE file based on the PE file characteristics comprises:
when a similarity between the extracted PE file characteristics and the PE file characteristics for a second PE file reaches a preset threshold, generating a PE file identifier for the PE file identical to the PE file identifier for the second PF file; and
when the similarity between the extracted PE file characteristics and the PE file characteristics for a second PE file does not reach a preset threshold, generating a PE file identifier for the PE file different from the PE file identifier for the second PF file.

4. The method of claim 3, wherein when the PE file identifier is a number, the method further comprises:
when the extracted PE file characteristics are partially identical to the PE file characteristics for the second PE file, determining the difference between the PE file identifier for the PE file and the PE file identifier for the second PE file based on the number of identical PE file characteristics.

5. The method of claim 1, wherein clustering the PE file base on the PE file identifier comprises:
classifying all PE files with the same PE file identifier into a same class; and
clustering all PE files in the same class, and identifying all PE file in the same class using the PE file identifier.

6. An apparatus for clustering portable executable (PE) files, comprising:
an extraction module for extracting PE file characteristics from a PE file;
a generation module for generating a PE file identifier for the PE file based on the PE file characteristics; and
a clustering module for clustering the PE file base on the PE file identifier.

7. The apparatus of claim 6, wherein the extraction module is configured for, after extracting PE file characteristics from a PE file, forming a PE file characteristic set using the extracted PE file characteristics, wherein the PE file characteristic set comprises at least one PE file characteristic; and
the generation module is configured for generating a PE file identifier for the PE file based on the PE file characteristics comprises generating a PE file identifier for the PE file based on the PE file characteristic set.

8. The apparatus of claim 6, wherein the generation module further comprises:
a first processing unit for, when a similarity between the extracted PE file characteristics and the PE file characteristics for a second PE file reaches a preset threshold, generating a PE file identifier for the PE file identical to the PE file identifier for the second PF file; and
a second processing unit for, when the similarity between the extracted PE file characteristics and the PE file characteristics for a second PE file does not reach a preset threshold, generating a PE file identifier for the PE file different from the PE file identifier for the second PF file.

9. The apparatus of claim 8, wherein the generating module comprises:
a third processing unit for, when the extracted PE file characteristics are partially identical to the PE file characteristics for the second PE file, determining the difference between the PE file identifier for the PE file and the PE file identifier for the second PE file based on the number of identical PE file characteristics.

10. The apparatus of claim 6, wherein the clustering module comprises:
a clustering unit for classifying all PE files with the same PE file identifier into a same class and clustering all PE files in the same class; and
an identification unit for identifying all PE files in the same class using the PE file identifier.

11. A computer-readable medium having stored thereon computer-executable instructions, said computer-executable instructions for performing a method for clustering files, the method comprising:
extracting a plurality of file characteristics from a file, wherein each file characteristic reflects certain characteristic information of the file;
forming a file characteristic set by arranging the extracted file characteristics in a predetermined order;
applying a fingerprinting algorithm on the file characteristic set to generate a file identifier for the file; and
clustering the file base on the file identifier.

12. The computer-readable medium of claim 11, wherein the fingerprinting algorithm is a SimHash algorithm.

13. The computer-readable medium of claim 11, wherein the file is a portable executable (PE) file.

14. The computer-readable medium of claim 11, wherein each file characteristic is a constant string in the file.

15. The computer-readable medium of claim 11, wherein each file characteristic is selected from a group consisting of an instruction sequence, an import function name, an export function name and a visible string in the file.

16. The computer-readable medium of claim 11, wherein applying a fingerprinting algorithm on the file characteristic set to generate a file identifier for the file further comprises:
defining a similarity index;
setting a similarity threshold; and
generating a file identifier for the file identical to a file identifier for a second file when the similarity index between the extracted file characteristics and the file characteristics for a second file reaches the similarity threshold.

17. The computer-readable medium of claim 11, wherein clustering the file base on the file identifier comprises:
classifying all files with the same PE file identifier into a same class; and
identifying all file in the same class using the file identifier.
